(19) United States
(12) Patent Application Publication
(10) Pub. No.: US 2017/0118808 A1
(43) Pub. Date: Apr. 27, 2017

(54) WALL MOUNTED AC TO DC CONVERTER GANG BOX

(71) Applicant: ERP POWER, LLC, Moorpark, CA (US)

(72) Inventor: Michael Archer, Moorpark, CA (US)

(21) Appl. No.: 15/336,751

(22) Filed: Oct. 27, 2016

Related U.S. Application Data
(60) Provisional application No. 62/247,032, filed on Oct. 27, 2015.

(51) Int. Cl. H05B 33/08

(52) U.S. Cl. CPC H05B 33/0815; H05B 33/0845

(57) ABSTRACT

A wall-mounted AC to DC converter gang box designed to replace light switches in order to provide dimming capabilities and drive LED illumination devices without needing to replace existing building wiring.

### CROSS-REFERENCE TO RELATED APPLICATION(S)

The application claims priority to and the benefit of U.S. Provisional Application 62/247,032 filed on Oct. 27, 2015, the entire content of which is incorporated herein by reference.

### TECHNICAL FIELD

This invention relates to wall-mounted control circuits for Light Emitting Diode (LED) illumination devices.

### BACKGROUND

The efficiency of light sources has improved through technological advances in materials and semiconductors. Electroluminescent lamps using LEDs have replaced traditional light sources, such as incandescent and neon lamps. With the increased demand for energy efficiency, there is an increased demand on retrofitting traditional wall installations in buildings to be compatible with LED illumination devices.

The increased demand for energy efficiency has also increased the demand to make lighting installations compatible with lighting dimmers. Lighting dimmers can control the intensity of a light source, thus reducing energy used when a light source is not required to be on at full intensity. Lighting dimmers, such as NEC approved junction boxes, typically take in an AC power signal and output a modified AC waveform that provides lower power.

A traditional lighting installation typically comprises a wall switch gang box connected to an AC line voltage, an incandescent lighting module, and wiring between the wall switch gang box and the incandescent lighting module. In replacing a traditional lighting installation, each of these components is typically replaced. The wall switch gang box is replaced with a dimmer switch gang box, the incandescent bulb is replaced with a power supply and an LED lighting module, and the internal wiring is replaced to accommodate the power supply between the dimmer switch gang box and the LED lighting module. The replacement of internal wiring may be particularly difficult and laborious, as wiring is typically installed in tight spaces in the walls.

FIG. 1 shows an example block diagram of a prior art replacement lighting installation 100. The dimmer switch module, such as a TRIAC module 104 installed in a gang box 110, receives an AC line voltage input 102 and outputs a modified AC voltage signal to provide a varying RMS voltage through in-wall wiring 112 to the power supply module 106, such as an external power supply for an LED lamp. The power supply module 106 converts this modified AC voltage signal to a DC voltage signal to drive the LED illumination device 108. As traditional lighting installations do not account for the external power supply module 106 included in this installation, new in-wall wiring 112 and additional wiring 114 between the power supply module 106 and LED illumination device 108 is required.

For the foregoing reasons there is a need for a retrofit lighting installation that provides dimming capabilities with LED lighting module support and that does not require the replacement of existing building wiring.

### SUMMARY

The present invention is directed to an apparatus that provides dimming capabilities with LED lighting modules without the need for replacement of pre-established building wiring between a gang box and lighting module. The apparatus comprises a wall-mounted gang box, an AC to DC converter contained within the wall-mounted gang box to convert an AC line voltage into a DC voltage output, and a dimming interface to control the DC voltage output level, wherein the wall-mounted gang box is operable to directly drive an LED lighting module without a power supply between the gang box and the LED lighting module.

It is an object of the present invention to reduce the labor required in retrofitting lighting installations by providing an apparatus to replace light switches that does not require replacement of pre-existing wire installations.

### BRIEF DESCRIPTION OF DRAWINGS

FIG. 1 depicts a block diagram of a lighting installation as known in the prior art;

FIG. 2 depicts a block diagram of a lighting installation in accordance with an embodiment of the present disclosure;

FIG. 3 depicts a perspective view of an embodiment of an integrated wall-mounted AC to DC converter gang box in accordance with an embodiment of the present disclosure;

FIG. 4 depicts a side view of an embodiment of an integrated wall-mounted AC to DC converter gang box in accordance with an embodiment of the present disclosure; and

FIG. 5 depicts a block diagram of an integrated wall-mounted AC to DC converter gang box in accordance with an embodiment of the present disclosure.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

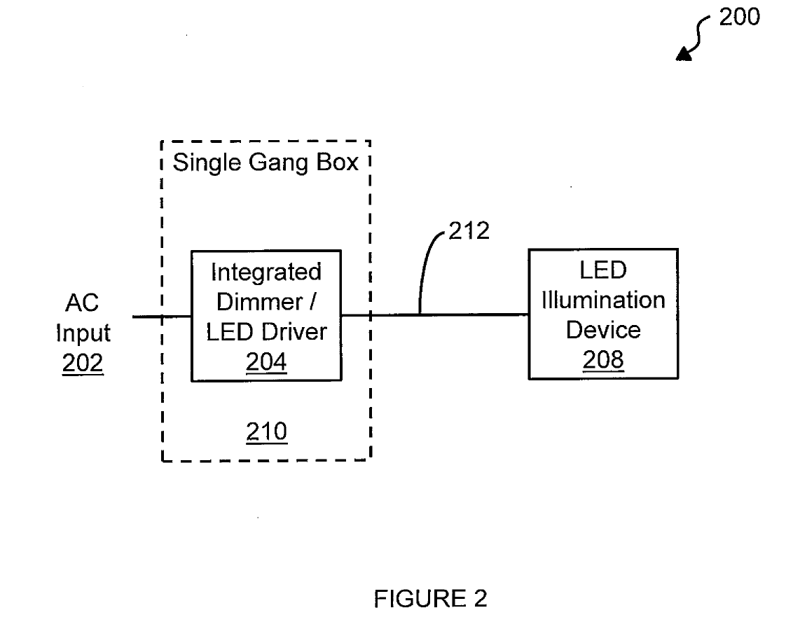

Referring to FIG. 2, a block diagram of a new lighting installation 200 in accordance with the present invention is shown using the wall-mounted AC to DC single gang box 210. As shown, the AC to DC single gang box receives an AC line voltage input 202 and converts it to a variable DC voltage, wherein the DC voltage is dependent on the dimmer interface settings. The DC output is transferred via the existing building wiring 212 in order to power the LED illumination device 208.

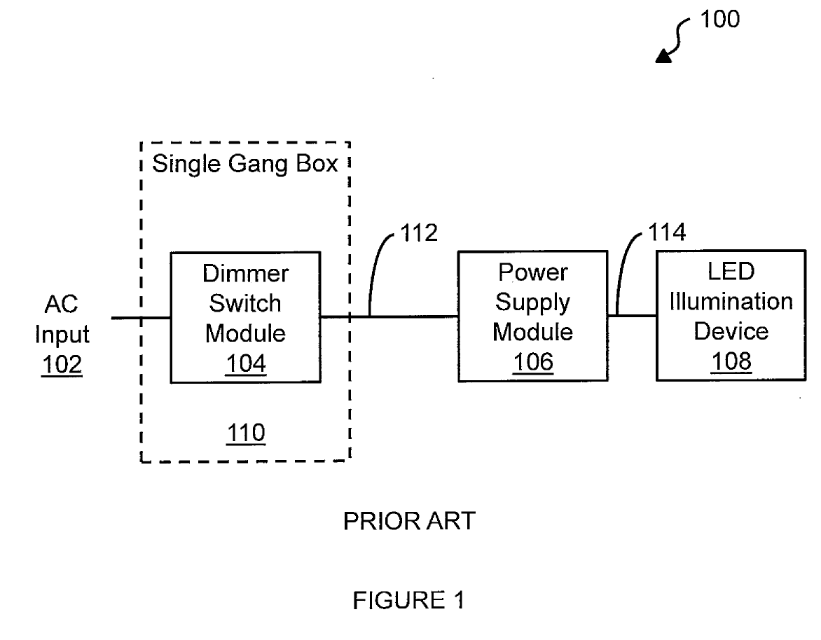

The dimmer function of the prior art lighting installation 100 differs from the dimmer function of the wall-mounted AC to DC converter gang box installation 200 in the type of power being regulated. The dimmer switch module 104 of FIG. 1 is an AC altering device, typically a triac. The triac 104 alters an AC line voltage in order to provide a modified AC voltage that is transferred via new wiring 112 to a power supply module 106, wherein the modified AC voltage is converted to DC voltage. Rather than modifying the AC line voltage like the prior art dimmer switch module 104, the dimming interface of the present invention modifies a DC voltage output of the single gang box 210. The modified DC voltage output is then transferred via housing wiring 212 to the LED illumination device 208.

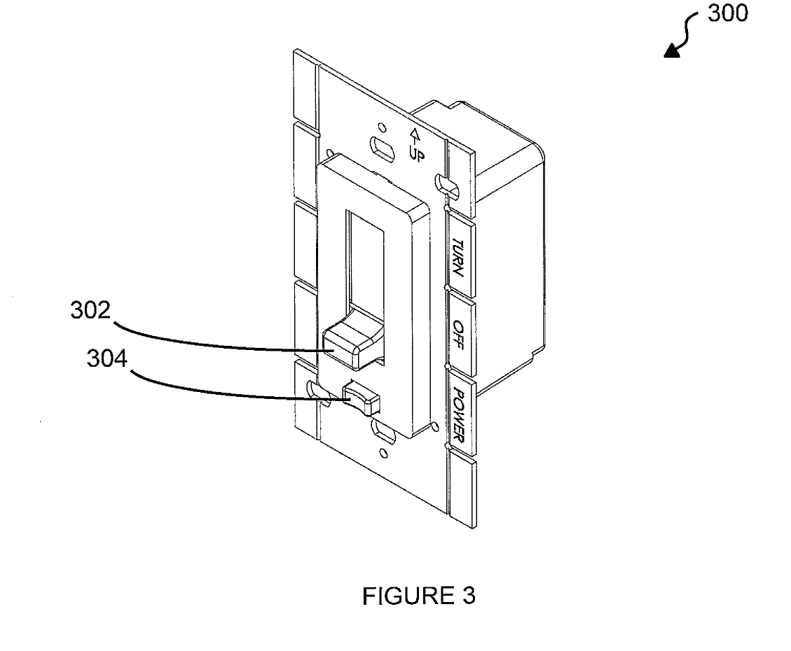

Referring to FIG. 3, an embodiment of the wall-mounted AC to DC single gang box 300 is shown. The gang box is NEC compliant and is designed to replace wall-mounted light switch installations. As shown, a slider 302 can determine a sliding scale of DC voltage output to an LED illumination device 208, and a switch 304 having an “on” state and an “off” state can turn the LED illumination device on or off while preserving the slider position. While the dimming interface shown is a manual analog slider, the dimming interface may also include other types of input to determine a level of DC voltage output to the LED lighting fixture. For example only, the dimming interface may be a digital interface compatible with intelligent control systems. In some embodiments, the intelligent control systems incorporate motion sensing and/or timed dimming in order to reduce power consumption.

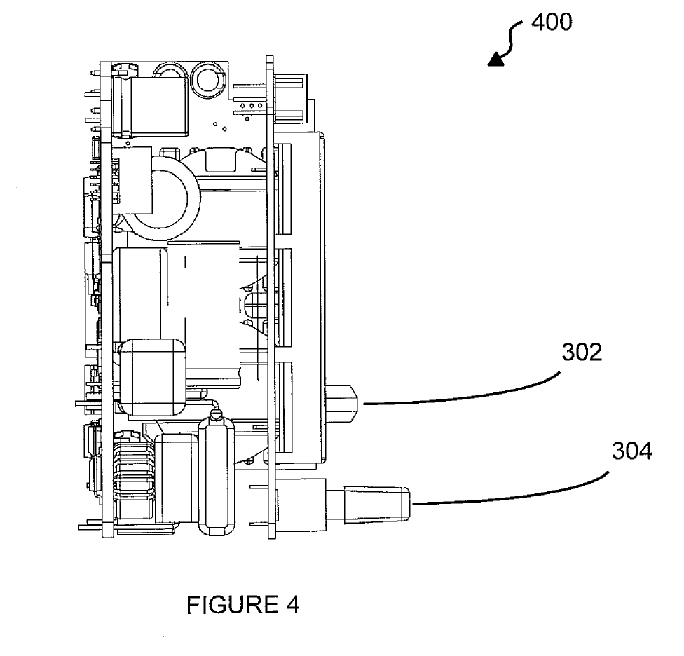

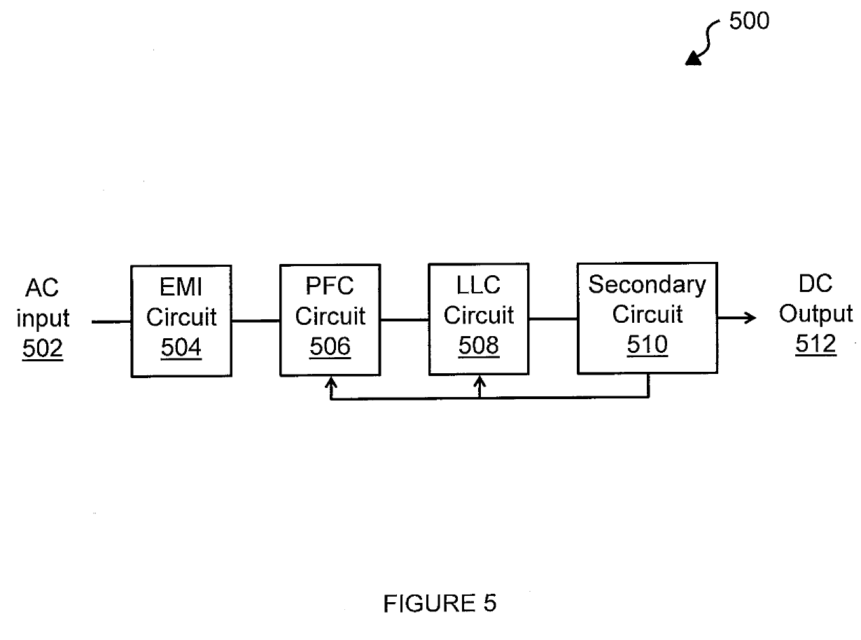

FIG. 4 depicts a side view of the internal components of an embodiment of the AC to DC converter gang box with the paneling removed for clarity. The circuitry is compact and efficient in order to fit in a standard wall installation. FIG. 5 shows a block diagram of the internal components of an embodiment of the AC to DC converter gang box. The AC input voltage 502 is filtered through an EMI filter circuit 504 in order to reduce electromagnetic interference before being transferred to the other components of the circuit. A power factor correction circuit 506 reduces the amount of reactive power generated in order to maintain high efficiency, operating based on input from the EMI filter circuit 504 and the secondary circuit 510. The LLC resonant converter circuit 508 converts the filtered AC line voltage to DC voltage. The secondary circuit 510 monitors the DC voltage output 512 and provides signals to the power factor correction circuit 506 and the LLC resonant converter circuit 508 in order to maintain efficient output and correct for voltage and current conditions. The DC output 512 is modified by the dimming interface before being transferred through existing building wiring 212 to an LED illumination device 208. This configuration is highly efficient and packed in a single gang box 210.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. An LED driver with dimming capabilities for driving an LED lighting module without the need for replacement of pre-established building wiring between a wall-mounted one-gang box and a lighting module, the driver comprising:
a dual-stage AC to DC converter disposed within the one-gang box to convert an AC line voltage into a DC voltage output, the AC to DC converter comprising a power factor correction (PFC) converter stage to receive an input voltage, perform power factor correction, and generate a first stage voltage, and a resonant converter stage to receive the first stage voltage and generate an output voltage;
a dimming interface, substantially disposed within the one-gang box, coupled to the AC to DC converter to modify the DC voltage output level of the driver for dimming the LED lighting module;
wherein the LED driver is operable to directly drive an LED lighting module without a power supply between the gang box and the LED lighting module.

2. The LED driver of claim 1, wherein the resonant converter stage comprises an LLC resonant converter.

3. The LED driver of claim 1, wherein a secondary circuit monitors the DC output voltage and provides signals to the PFC converter stage in order to maintain efficient output and correct for voltage and current conditions.

4. The LED driver of claim 1, wherein a secondary circuit monitors the DC output voltage and provides signals to the resonant converter stage in order to maintain efficient output and correct for voltage and current conditions.

5. The LED driver of claim 1, further comprising an electromagnetic interference circuit disposed within the one-gang box to reduce electromagnetic interference on the input voltage before the input voltage is transferred to the other components of the LED driver.

6. The LED driver of claim 1, further comprising a housing disposable within the one-gang box and containing the power converter and the secondary circuit.

7. A method of retrofitting a building with LED lighting without the need for replacement of pre-established building wiring between a gang box and a lighting module, the method comprising:
replacing the lighting module with an LED illumination device; and
installing an LED driver with dimming capabilities in the gang box, the LED driver being disposable within a one-gang box, the LED driver being operable to directly receive an AC power voltage from within the gang box from pre-existing wiring and directly drive the LED illumination device without a power supply between the gang box and the lighting module.

8. The method of claim 7 wherein the LED driver comprises a dual-stage AC to DC converter to convert the AC power voltage into a DC voltage output to drive the LED illumination device.

9. The method of claim 8, wherein the dual-stage AC to DC converter comprises a power factor correction (PFC) converter stage to receive an input voltage, perform power factor correction, and generate a first stage voltage, and a resonant converter stage to receive the first stage voltage and generate the DC voltage output.

10. An LED driver with dimming capabilities for driving an LED lighting module without the need for replacement of pre-established building wiring between a wall-mounted one-gang box and a lighting module, the driver comprising:
a housing disposable within the one-gang box and containing the power converter and the secondary circuit;
a dual-stage AC to DC converter disposed within the one-gang box to convert an AC line voltage into a DC voltage output, the AC to DC converter comprising a power factor correction (PFC) converter stage to receive an input voltage, perform power factor correction, and generate a first stage voltage, an LLC resonant converter stage to receive the first stage voltage and generate an output voltage, and a secondary circuit to monitor the DC output voltage and provide signals to the PFC converter stage and the resonant converter stage in order to maintain efficient output and correct for voltage and current conditions;
an electromagnetic interference circuit disposed within the one-gang box to reduce electromagnetic interference on the input voltage before the input voltage is transferred to the other components of the LED driver;
a dimming interface, substantially disposed within the one-gang box, coupled to the AC to DC converter to modify the DC voltage output level of the driver for dimming the LED lighting module; and
wherein the LED driver is operable to directly drive an LED lighting module without a power supply between the gang box and the LED lighting module.
